(19) United States
(12) Patent Application Publication
(10) Pub. No.: US 2020/0408463 A1
(43) Pub. Date: Dec. 31, 2020

(54) LIQUID AIR STORAGE DEVICE AND METHOD, AND AIR LIQUEFACTION APPARATUS

(71) Applicant: SICHUAN TIBO FLUID TECHNOLOGY CO., LTD., Jianyang (CN)

(72) Inventors: Qun HAO, Jianyang (CN); Xing LIU, Jianyang (CN)

(21) Appl. No.: 15/929,869

(22) Filed: May 27, 2020

(30) Foreign Application Priority Data
Jun. 28, 2019 (CN) 201910577591. 1

(51) Int. Cl. F25J 1/00; F04B 15/00; F17C 1/12; F17C 13/02

(52) U.S. Cl. CPC F25J 1/0012; F25J 1/0032; F25J 1/007; F04B 2015/0812; F17C 1/12; F17C 13/02; F04B 15/00

(57) ABSTRACT

The present invention discloses a liquid air storage device, including a storage tank, a gas circulation outlet pipe, a gas circulation inlet pipe, and a pump. An input end of the gas circulation outlet pipe communicates with the lower part of an inner cavity of the storage tank, an output end of the gas circulation outlet pipe communicates with an input end of the pump, an output end of the pump communicates with an input end of the gas circulation inlet pipe, and an output end of the gas circulation inlet pipe communicates with the upper part of the inner cavity of the storage tank. The present invention further discloses a liquid air storage method and an air liquefaction apparatus that use the foregoing liquid air storage device.

### CROSS-REFERENCE TO RELATED APPLICATIONS

This application claims priority to Chinese patent application number 201910577591.1 filed Jun. 28, 2019, the disclosure of which is incorporated by reference.

### TECHNICAL FIELD

The present invention relates to the field of liquid air storage, and in particular, to a liquid air storage device and method, and an air liquefaction apparatus.

### BACKGROUND

At present, some electronic products need to be produced in a specific gas environment, which has high requirements for the gas content. During the production of such electronic products, it is necessary to continuously supply standard-compliant air to meet the production environment requirements. Currently, air is stored as high-pressure gas or liquid air. The air stored as high-pressure gas takes up large space, with a low storage capacity but high gas pressure of more than 15 MPa. This poses high potential risks. The air stored as liquid contains various gases, which have different densities after liquefaction. After stored in a storage device for a period of time, different liquefied gases are layered. When the air in the storage device is used, the gases are discharged in an order they are layered, and components of the discharged gases cannot meet the production requirements.

### SUMMARY

The present invention is intended to provide a liquid air storage device and method, and an air liquefaction apparatus, which can avoid layering of the liquid gases stored in a storage tank and keep the liquid air in the storage tank unchanged.

In order to achieve the above objectives, a specific technical solution adopted by the present invention is as follows:

The present invention discloses a liquid air storage device, including a storage tank, a gas circulation outlet pipe, a gas circulation inlet pipe, and a pump. An input end of the gas circulation outlet pipe communicates with the lower part of an inner cavity of the storage tank, an output end of the gas circulation outlet pipe communicates with an input end of the pump, an output end of the pump communicates with an input end of the gas circulation inlet pipe, and an output end of the gas circulation inlet pipe communicates with the upper part of the inner cavity of the storage tank.

The present invention has the following beneficial effects: The liquid air in the lower part of the storage tank is drawn through the storage air circulation outlet pipe, the storage air circulation inlet pipe, and the pump, and then injected from the upper part of the storage tank, so that the liquid air in the upper part and lower part of the storage tank circulates to prevent layering of the liquid air in the storage tank due to different densities of the gas components and keep the liquid air in the storage tank unchanged.

The liquid air storage device further includes a heat exchanger A, a vaporized gas overflow pipe, a liquefied gas reinjection pipe, a refrigerant A injection pipe, and a refrigerant A discharge pipe. An input end of the vaporized gas overflow pipe is connected to the top of the storage tank and communicates with the upper part of the inner cavity of the storage tank, an output end of the vaporized gas overflow pipe communicates with an input end of a hot runner of the heat exchanger A, an output end of the hot runner of the heat exchanger A communicates with an input end of the liquefied gas reinjection pipe, an output end of the liquefied gas reinjection pipe is connected to the bottom of the storage tank and communicates with the lower part of the inner cavity of the storage tank, an output end of the refrigerant A injection pipe communicates with an input end of a cold runner of the heat exchanger A, and an output end of the cold runner of the heat exchanger A communicates with an input end of the refrigerant A discharge pipe.

The beneficial effects of the foregoing solution are as follows: The gas generated by endothermic vaporization of the liquid air stored in the storage tank is liquefied by exchanging heat with refrigerant A through the heat exchanger A, and the liquefied gas is injected into the storage tank through the liquefied gas injection pipe. In this way, the liquid air inside the storage tank stays in a liquid state without being vaporized, keeping the components of the liquid air unchanged.

Further, the storage tank includes an inner shell, an outer shell, and a thermal insulation layer, the inner shell is inside the outer shell, the thermal insulation layer is between the inner shell and the outer shell, and the liquid air is stored inside the inner shell.

The beneficial effects of the foregoing solution are as follows: The storage tank is kept in a low temperature, preventing the liquid gas in the storage tank from being vaporized.

Further, both the gas circulation outlet pipe and the gas circulation inlet pipe are thermal insulation pipes.

The beneficial effects of the foregoing solution are as follows: The liquid air flowing inside the gas circulation outlet pipe and the gas circulation inlet pipe stays in a liquid state without being vaporized.

The liquid air storage device further includes a gas concentration tester A, a gas concentration tester B, and a gas concentration tester C. A probe of the gas concentration tester A is disposed at the top of the storage tank, a probe of the gas concentration tester B is disposed at the bottom of the storage tank, and a probe of the gas concentration tester C is disposed in the middle of the storage tank.

The beneficial effects of the foregoing solution are as follows: Whether the liquid air stored in the storage tank is layered can be monitored.

The present invention discloses a liquid air storage method, where the foregoing liquid air storage device is used to allow the liquid air stored in the upper part and lower part of the storage tank to circulate through the pump, the gas circulation outlet pipe, and the gas circulation inlet pipe, so that the liquid air stored in the storage tank is mixed uniformly.

The beneficial effects of the present invention are as follows: The liquid air stored in the storage tank is prevented from being layered, so that the liquid air stored in the storage tank does not change and the components of the gas in the storage tank can meet the production requirements.

The present invention discloses an air liquefaction apparatus, including a compression and cooling device, an expander, a heat exchanger B, an air input pipe, an air output pipe, and the foregoing liquid air storage device. An output end of the compression and cooling device communicates with an input end of the expander through a pipeline, an output end of the expander communicates with an input end of a cold runner of the heat exchanger B through a pipeline, an output end of the cold runner of the heat exchanger B communicates with an input end of the compression and cooling device through a pipeline, an output end of the air input pipe communicates with an input end of a hot runner of the heat exchanger B, an input end of the air output pipe communicates with an output end of the hot runner of the heat exchanger B, and an output end of the air output pipe communicates with the inner cavity of the storage tank.

The beneficial effects of the present invention are as follows: The compressed, cooled, and expanded refrigerant B gas exchanges heat with the air to liquefy the air. The refrigerant B gas only needs to be compressed to about 1.3 MPa, and the pressure applied to the refrigerant B gas is small. Compared with the existing compressed and purified gas storage method or pressurization-based liquefaction method, this method does not apply a large pressure to the air, avoiding the potential safety risks from high-pressure gas and high-temperature liquid. This method does not require high device performance, requires less work, and consumes less energy. The produced liquid air is stored in the storage tank and will not be layered, so that the components of the gas can meet the requirements.

Further, the compression and cooling device includes a compressor A, a cooler A, a compressor B, and a cooler B. An output end of the compressor A communicates with an input end of the cooler A through a pipeline, an output end of the cooler A communicates with an input end of the compressor B through a pipeline, an output end of the compressor B communicates with an input end of the cooler B through a pipeline, an output end of the cooler B communicates with the input end of the expander, and the output end of the cold runner of the heat exchanger B communicates with an input end of the compressor A through a pipeline.

The beneficial effects of the foregoing solution are as follows: Through distributed compression, the pressure applied by the device to the refrigerant B is small, and the temperature of the refrigerant B gas does not rise too much, ensuring the safety. In addition, the refrigerant B gas is cooled after each compression, protecting the compressor from overhigh temperature.

The air liquefaction apparatus further includes a refrigerant B supplement pipe, a refrigerant B discharge pipe, and a pressure tester. The pressure tester is disposed on the pipeline between the output end of the cold runner of the heat exchanger B and the input end of the compression and cooling device, an output end of the refrigerant B supplement pipe and an input end of the refrigerant B discharge pipe communicate with the pipeline between the output end of the cold runner of the heat exchanger B and the input end of the compression and cooling device, a valve A is provided on the refrigerant B supplement pipe, and a valve B is provided on the refrigerant B discharge pipe.

The beneficial effects of the foregoing solution are as follows: The pressure of the circulating refrigerant B gas can be detected. If the pressure is too high, the valve B can be opened to let the refrigerant B gas out. If the pressure is too low, the valve A can be opened to supplement the refrigerant B gas. This can ensure safety with satisfactory cooling effect of the refrigerant B gas.

The air liquefaction apparatus further includes a heating refrigerant gas pipe. An output end of the heating refrigerant gas pipe communicates with the output end of the expander.

The beneficial effects of the foregoing solution are as follows: When air liquefaction stops, the expander, the cold runner of the heat exchanger B, and corresponding low-temperature pipelines are still full of the extremely cold refrigerant B gas, which is likely to cause danger. After the refrigerant B gas is heated, the expander, the cold runner of the heat exchanger, and the corresponding low-temperature pipelines return to room temperature, eliminating potential safety risks.

### BRIEF DESCRIPTION OF DRAWINGS

FIG. 1 is schematic diagram 1 of a liquid air storage device.

FIG. 2 is schematic diagram 2 of a liquid air storage device.

FIG. 3 is a schematic diagram of an air liquefaction apparatus. In the figure:
1. storage tank,
11. inner shell,
12. thermal insulation layer,
13. outer shell,
14. probe of a gas concentration tester A,
15. probe of a gas concentration tester B,
16. probe of a gas concentration tester C,
21. liquid air injection pipe,
22. vaporized gas overflow pipe,
23. liquefied gas reinjection pipe,
24. refrigerant A injection pipe,
25. refrigerant A discharge pipe,
26. gas output pipe,
27. gas circulation inlet pipe,
28. gas circulation outlet pipe,
29. cryopump,
3. heat exchanger A, and
4. pump.

### DETAILED DESCRIPTION

To make the objectives, technical solutions, and advantages of the present invention clearer, the following describes the present invention in more detail with reference to the accompanying drawings.

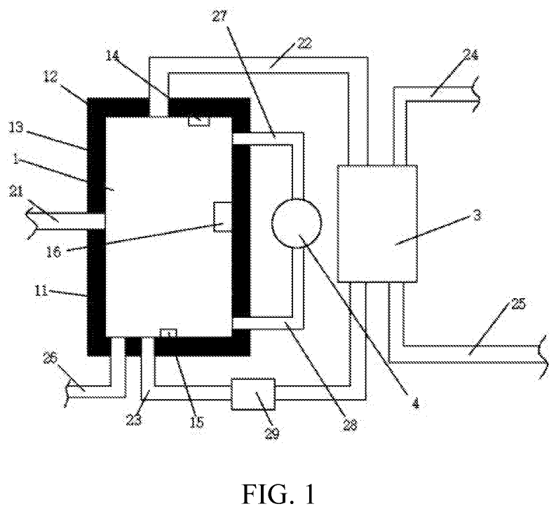

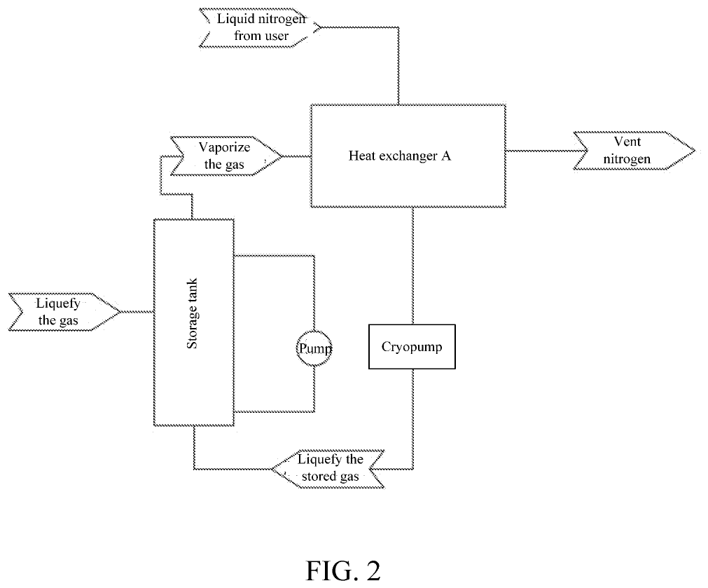

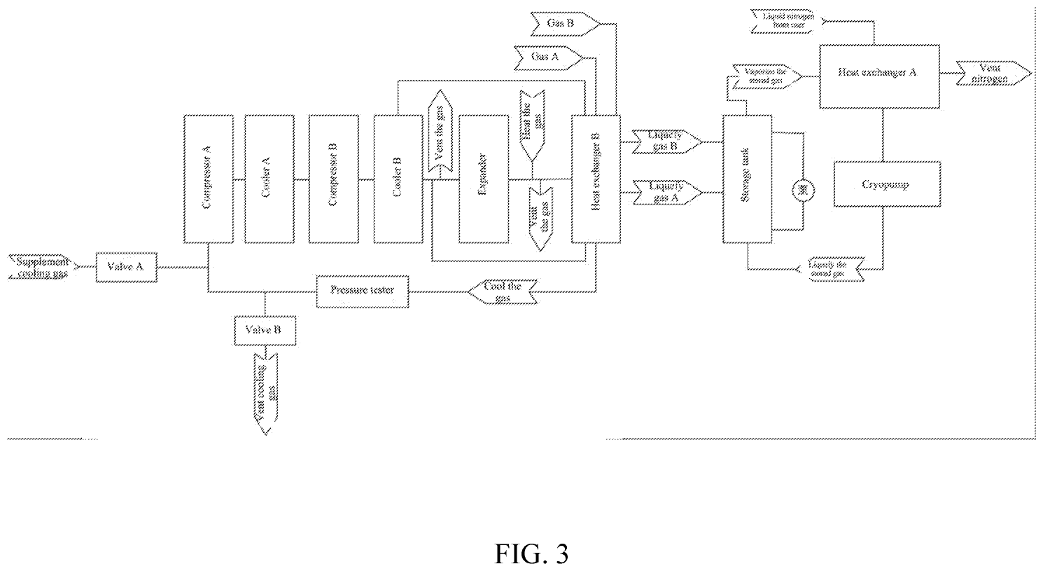

As shown in FIG. 1 and FIG. 2, a liquid air storage device disclosed in the present invention includes a storage tank 1, a gas circulation outlet pipe 28, a gas circulation inlet pipe 27, a pump 4, a heat exchanger A 3, a liquid air injection pipe 21, a vaporized gas overflow pipe 22, a liquefied gas injection pipe 23, a refrigerant A injection pipe 24, and a refrigerant A discharge pipe 25. An input end of the gas circulation outlet pipe 28 communicates with the lower part of an inner cavity of the storage tank 1. An output end of the gas circulation outlet pipe 28 communicates with an input end of the pump 4. An output end of the pump 4 communicates with an input end of the gas circulation inlet pipe 27. An output end of the gas circulation inlet pipe 27 communicates with the upper part of the inner cavity of the storage tank 1. An output end of the liquid air injection pipe 21 communicates with the inner cavity of the storage tank 1. An input end of the vaporized gas overflow pipe 22 is connected to the top of the storage tank 1 and communicates with the upper part of the inner cavity of the storage tank 1. An output end of the vaporized gas overflow pipe 22 communicates with an input end of a hot runner of the heat exchanger A 3. An output end of the hot runner of the heat exchanger A 3 communicates with an input end of the liquefied gas reinjection pipe 23. An output end of the liquefied gas reinjection pipe 23 is connected to the bottom of the storage tank 1 and communicates with the lower part of the inner cavity of the storage tank 1. A cryopump 29 is disposed on the gas reinjection pipe 23, and configured to re-inject the gas liquefied through heat exchange by the heat exchanger A 3 into the storage tank 1. The cryopump 29 provides power for re-injecting the liquefied gas into the storage tank 1, and is located outside the storage tank 1. An output end of the refrigerant A injection pipe 24 communicates with an input end of a cold runner of the heat exchanger A 3. An output end of the cold runner of the heat exchanger A 3 communicates with an input end of the refrigerant A discharge pipe 25. An input end of a gas output pipe 26 communicates with the lower part of the inner cavity of the storage tank 1. Air meeting the requirements is supplied to a working part through the storage air output pipe 26.

The storage tank 1 includes an inner shell 11, an outer shell 13, and a thermal insulation layer 12. The inner shell 11 is inside the outer shell 13. The thermal insulation layer 12 is between the inner shell 11 and the outer shell 13. The liquid air is stored inside the inner shell 11.

Both the heat exchanger A 3 and the pump 4 are provided outside the storage tank 1.

The liquid air storage device further includes a gas concentration tester A, a gas concentration tester B, and a gas concentration tester C. A probe 14 of the gas concentration tester A is disposed at the top of the storage tank 1, a probe 15 of the gas concentration tester B is disposed at the bottom of the storage tank 1, and a probe 16 of the gas concentration tester C is disposed in the middle of the storage tank 1. The gas concentration tester A, the gas concentration tester B, and the gas concentration tester C are all oxygen concentration testers, which can monitor whether the liquid gases at the top, middle and bottom of the storage tank 1 are layered.

Liquid nitrogen from a user end is led to an input end of the refrigerant A injection pipe 24.

The gas circulation outlet pipe 28, the gas circulation inlet pipe 27, the liquid air injection pipe 21, the liquefied gas reinjection pipe 23, and the refrigerant A injection pipe 24 are all thermal insulation pipes.

The present invention discloses a liquid air storage method, where the foregoing liquid air storage device is used to allow the liquid air stored in the upper part and lower part of the storage tank 1 to circulate through the pump 4, the gas circulation outlet pipe 28, and the gas circulation inlet pipe 27, so that the liquid air stored in the storage tank 1 is mixed uniformly. This ensures the components of the air in the storage tank 1 meet the standards, avoiding sequential use of the gases of different densities.

As shown in FIG. 3, an air liquefaction apparatus disclosed by the present invention includes a compression and cooling device, an expander, a heat exchanger B, an air input pipe, an air output pipe, and the foregoing liquid air storage device. An output end of the compression and cooling device communicates with an input end of the expander through a pipeline. An output end of the expander communicates with an input end of a cold runner of the heat exchanger B through a pipeline. An output end of the cold runner of the heat exchanger B communicates with an input end of the compression and cooling device through a pipeline. An output end of the air input pipe communicates with an input end of a hot runner of the heat exchanger B. An input end of the air output pipe communicates with an output end of the hot runner of the heat exchanger B. An output end of the air output pipe communicates with an input end of the liquid air injection pipe 21.

The hot runner of the heat exchanger B includes a hot runner A for cooling refrigerant B and a hot runner B for cooling the air. The output end of the air input pipe communicates with an input end of the hot runner B of the heat exchanger B. The input end of the air output pipe communicates with an output end of the hot runner B of the heat exchanger B. An input end of the hot runner A of the heat exchanger B communicates with an output end of the compression and cooling device through a pipeline. An output end of the hot runner A of the heat exchanger B communicates with the input end of the expander through a pipeline. The refrigerant B processed by the compression and cooling device enters the hot runner A of the heat exchanger B, is cooled by exchanging heat with the refrigerant B passing through the expander, and then cooled by the expander through expansion. The refrigerant B cooled by the expander enters the cold runner of the heat exchanger B. This further saves resources. The heat exchanger B is preferably a plate heat exchanger.

The compression and cooling device includes a compressor A, a cooler A, a compressor B, and a cooler B. An output end of the compressor A communicates with an input end of the cooler A through a pipeline. An output end of the cooler A communicates with an input end of the compressor B through a pipeline. An output end of the compressor B communicates with an input end of the cooler B through a pipeline. An output end of the cooler B communicates with the input end of the expander. The output end of the cold runner of the heat exchanger B communicates with an input end of the compressor A through a pipeline. The cooler A and the cooler B each are provided with a circulating water cooling system. The input end of the hot runner A of the heat exchanger B communicates with the output end of the cooler B through a pipeline.

The air liquefaction apparatus further includes a refrigerant B supplement pipe, a refrigerant B discharge pipe, and a pressure tester. The pressure tester is disposed on the pipeline between the output end of the cold runner of the heat exchanger B and the input end of the compression and cooling device. An output end of the refrigerant B supplement pipe and an input end of the refrigerant B discharge pipe communicate with the pipeline between the output end of the cold runner of the heat exchanger B and the input end of the compression and cooling device. A valve A is provided on the refrigerant B supplement pipe, and a valve B is provided on the refrigerant B discharge pipe.

The air liquefaction apparatus further includes a heating refrigerant gas pipe. An output end of the heating refrigerant gas pipe communicates with the output end of the expander.

Both the output end and the input end of the expander are provided with a venting pipe. A valve is provided on the venting pipe. The venting pipe at the input end of the expander is between the output end of the hot runner A of the heat exchanger B and the input end of the expander.

There is a plurality of hot runners B in the heat exchanger B, and a quantity of the air input pipes and air output pipes corresponds to a quantity of the hot runners B. The corresponding air input pipe, hot runner B in the heat exchanger B, and air output pipe are connected in sequence. One hot runner B and its corresponding air input pipe and air output pipe form an air liquefaction channel. Output ends of a plurality of air output pipes communicate with the inner cavity or cavities of the same or different storage tanks 1.

When the output ends of the plurality of air output pipes communicate with the inner cavity of the same storage tank 1, different gases can be delivered through the plurality of air output pipes, and components of the air stored in the storage tank 1 can be controlled by controlling the air volume delivered through each air output pipe.

An air liquefaction method includes the following steps:

Compress and cool refrigerant B gas: Compress the refrigerant B gas to turn the refrigerant B gas into a high-temperature and high-pressure gas, and then cool the high-temperature and high-pressure gas to turn the refrigerant B gas into a normal-temperature and high-pressure gas.

Expand the refrigerant B gas: Lead the cooled refrigerant gas into the expander for expansion, to reduce the pressure of the refrigerant gas and turn it into a low-temperature gas.

Liquefy the air: Lead the air and the refrigerant B gas passing through the expander into the heat exchanger B, so that the air and the refrigerant B gas exchange heat in the heat exchanger B to cool and liquefy the air.

Store the liquefied air: Store the liquefied air passing through the heat exchanger B in the storage tank 1, so that the liquid air in the upper part and lower part of the storage tank 1 circulates through the pump 1 and is mixed uniformly. Some of the air vaporized by the heat in the storage tank 1 is liquefied by the heat exchanger A 3 and injected back into the storage tank 1.

The refrigerant B gas passing through the heat exchanger B is compressed again, and the refrigerant B gas is used cyclically to exchange heat with the air.

The refrigerant gas turns into a low-pressure and low-temperature gas after expansion. The low-pressure refrigerant gas has a lower temperature.

In the step of expanding the refrigerant B gas, the pressure of the refrigerant B gas before entering the expander is 1.2 MPa to 1.4 MPa, preferably 1.3 MPa.

The temperature of the refrigerant B gas expanded by the expander is lower than −180° C., preferably lower than −190° C.

The step of compressing and cooling the refrigerant B gas includes primary compression, primary cooling, secondary compression, and secondary cooling. The refrigerant B gas enters the expander for expansion after the primary compression, primary cooling, secondary compression, and secondary cooling. After the primary compression, the pressure of the refrigerant B gas becomes 1.05 MPa to 1.2 MPa, preferably 1.1 MPa. After the secondary compression, the pressure of the refrigerant B gas becomes 1.2 MPa to 1.4 MPa, preferably 1.3 MPa. The refrigerant B gas is cooled by circulating cooling water respectively after the primary compression and secondary compression. The temperature of the cooled gas is less than 40° C.

The compressed and cooled refrigerant B gas enters the heat exchanger to exchange heat with the refrigerant gas that has been depressurized and cooled, and then enters the expander for cooling. The refrigerant gas cooled by the expander is used to cool the air and the refrigerant gas that has been compressed and cooled.

There is still a heating step. After air liquefaction stops, the expander, the cold runner of the heat exchanger B, and the corresponding low-temperature pipeline are full of low-temperature gas, which may frostbite the operators and devices. Heated refrigerant B gas can be applied to the expander, the heat exchanger B, and the low-temperature pipeline to restore them to room temperature.

Further, there is a step of supplementing and discharging refrigerant B gas. The pressure of the refrigerant B gas in the entire system is detected. When the pressure of the refrigerant B gas in the system is too high, some of the refrigerant B gas is discharged. When the pressure of the refrigerant B gas in the system is too small, refrigerant B gas is injected into the refrigerant B gas circulation pipeline.

The refrigerant B gas can be nitrogen, and the liquefiable purified gas includes nitrogen, oxygen, and air of different components. A plurality of hot runners B may be arranged in the heat exchanger B, to communicate with a plurality of air liquefaction channels and liquefy a variety of different air at the same time.

The liquefied air enters the storage tank 1 for storage. During the storage, the liquid air absorbs heat, and the gas with a low vaporization temperature first vaporizes, rises to the top of the storage tank 1, enters the heat exchanger A 3 through the vaporized gas overflow pipe 22, and is liquefied by exchanging heat with refrigerant A. The liquefied gas is injected into the storage tank 1 through the liquefied gas reinjection pipe 23.

Both the refrigerant A and refrigerant B are nitrogen. The output end of the refrigerant A discharge pipe 25 is connected to the outside atmosphere.

A valve is provided on each pipeline of the liquid air storage device and the air liquefaction apparatus.

Certainly, the present invention may further include other various embodiments. A person skilled in the art can make various corresponding modifications and variations according to the present invention without departing from the spirit and essence of the present invention, but all these corresponding modifications and variations shall fall within the protection scope defined by the appended claims in the present invention.

What is claimed is:

1. A liquid air storage device, comprising a storage tank (1), a gas circulation outlet pipe (28), a gas circulation inlet pipe (27), and a pump (4), wherein an input end of the gas circulation outlet pipe (28) communicates with the lower part of an inner cavity of the storage tank (1), an output end of the gas circulation outlet pipe (28) communicates with an input end of the pump (4), an output end of the pump (4) communicates with an input end of the gas circulation inlet pipe (27), and an output end of the gas circulation inlet pipe (27) communicates with the upper part of the inner cavity of the storage tank (1).

2. The liquid air storage device according to claim 1, further comprising: a heat exchanger A (3), a vaporized gas overflow pipe (22), a liquefied gas reinjection pipe (23), a refrigerant A injection pipe (24), and a refrigerant A discharge pipe (25), wherein an input end of the vaporized gas overflow pipe (22) is connected to the top of the storage tank (1) and communicates with the upper part of the inner cavity in the storage tank (1), an output end of the vaporized gas overflow pipe (22) communicates with an input end of a hot runner of the heat exchanger A (3), an output end of the hot runner of the heat exchanger A (3) communicates with an input end of the liquefied gas reinjection pipe (23), an output end of the liquefied gas reinjection pipe (23) is connected to the bottom of the storage tank (1) and communicates with the lower part of the inner cavity in the storage tank (1), an output end of the refrigerant A injection pipe (24) communicates with an input end of a cold runner of the heat exchanger A (3), and an output end of the cold runner of the heat exchanger A (3) communicates with an input end of the refrigerant A discharge pipe (25).

3. The liquid air storage device according to claim 1, wherein the storage tank (1) comprises an inner shell (11), an outer shell (13), and a thermal insulation layer (12), wherein the inner shell (11) is inside the outer shell (13), and the thermal insulation layer (12) is between the inner shell (11) and the outer shell (13), and liquid air is stored inside the inner shell (11).

4. The liquid air storage device according to claim 1, wherein both the gas circulation outlet pipe (28) and the gas circulation inlet pipe (27) are thermal insulation pipes.

5. The liquid air storage device according to claim 1, further comprising: a gas concentration tester A, a gas concentration tester B, and a gas concentration tester C, wherein a probe (14) of the gas concentration tester A is disposed at the top of the storage tank (1), a probe (15) of the gas concentration tester B is disposed at the bottom of the storage tank (1), and a probe (16) of the gas concentration tester C is disposed in the middle of the storage tank (1).

6. The liquid air storage device according to claim 2, further comprising: a gas concentration tester A, a gas concentration tester B, and a gas concentration tester C, wherein a probe (14) of the gas concentration tester A is disposed at the top of the storage tank (1), a probe (15) of the gas concentration tester B is disposed at the bottom of the storage tank (1), and a probe (16) of the gas concentration tester C is disposed in the middle of the storage tank (1).

7. The liquid air storage device according to claim 3, further comprising: a gas concentration tester A, a gas concentration tester B, and a gas concentration tester C, wherein a probe (14) of the gas concentration tester A is disposed at the top of the storage tank (1), a probe (15) of the gas concentration tester B is disposed at the bottom of the storage tank (1), and a probe (16) of the gas concentration tester C is disposed in the middle of the storage tank (1).

8. The liquid air storage device according to claim 4, further comprising: a gas concentration tester A, a gas concentration tester B, and a gas concentration tester C, wherein a probe (14) of the gas concentration tester A is disposed at the top of the storage tank (1), a probe (15) of the gas concentration tester B is disposed at the bottom of the storage tank (1), and a probe (16) of the gas concentration tester C is disposed in the middle of the storage tank (1).

9. A liquid air storage method, wherein the liquid air storage device according to claim 1 is used to allow liquid air stored in the upper part and lower part of the storage tank (1) to circulate through the pump (4), the gas circulation outlet pipe (28), and the gas circulation inlet pipe (27), so that the liquid air stored in the storage tank (1) is mixed uniformly.

10. A liquid air storage method, wherein the liquid air storage device according to claim 2 is used to allow liquid air stored in the upper part and lower part of the storage tank (1) to circulate through the pump (4), the gas circulation outlet pipe (28), and the gas circulation inlet pipe (27), so that the liquid air stored in the storage tank (1) is mixed uniformly.

11. A liquid air storage method, wherein the liquid air storage device according to claim 3 is used to allow liquid air stored in the upper part and lower part of the storage tank (1) to circulate through the pump (4), the gas circulation outlet pipe (28), and the gas circulation inlet pipe (27), so that the liquid air stored in the storage tank (1) is mixed uniformly.

12. A liquid air storage method, wherein the liquid air storage device according to claim 4 is used to allow liquid air stored in the upper part and lower part of the storage tank (1) to circulate through the pump (4), the gas circulation outlet pipe (28), and the gas circulation inlet pipe (27), so that the liquid air stored in the storage tank (1) is mixed uniformly.

13. A liquid air storage method, wherein the liquid air storage device according to claim 5 is used to allow liquid air stored in the upper part and lower part of the storage tank (1) to circulate through the pump (4), the gas circulation outlet pipe (28), and the gas circulation inlet pipe (27), so that the liquid air stored in the storage tank (1) is mixed uniformly.

14. An air liquefaction apparatus, comprising: a compression and cooling device, an expander, a heat exchanger B, an air input pipe, an air output pipe, and the liquid air storage device according to claim 1, wherein an output end of the compression and cooling device communicates with an input end of the expander through a pipeline, an output end of the expander communicates with an input end of a cold runner of the heat exchanger B through a pipeline, an output end of the cold runner of the heat exchanger B communicates with an input end of the compression and cooling device through a pipeline, an output end of the air input pipe communicates with an input end of a hot runner of the heat exchanger B, an input end of the air output pipe communicates with an output end of the hot runner of the heat exchanger B, and an output end of the air output pipe communicates with the inner cavity of the storage tank (1).

15. An air liquefaction apparatus, comprising: a compression and cooling device, an expander, a heat exchanger B, an air input pipe, an air output pipe, and the liquid air storage device according to claim 2, wherein an output end of the compression and cooling device communicates with an input end of the expander through a pipeline, an output end of the expander communicates with an input end of a cold runner of the heat exchanger B through a pipeline, an output end of the cold runner of the heat exchanger B communicates with an input end of the compression and cooling device through a pipeline, an output end of the air input pipe communicates with an input end of a hot runner of the heat exchanger B, an input end of the air output pipe communicates with an output end of the hot runner of the heat exchanger B, and an output end of the air output pipe communicates with the inner cavity of the storage tank (1).

16. An air liquefaction apparatus, comprising: a compression and cooling device, an expander, a heat exchanger B, an air input pipe, an air output pipe, and the liquid air storage device according to claim 3, wherein an output end of the compression and cooling device communicates with an input end of the expander through a pipeline, an output end of the expander communicates with an input end of a cold runner of the heat exchanger B through a pipeline, an output end of the cold runner of the heat exchanger B communicates with an input end of the compression and cooling device through a pipeline, an output end of the air input pipe communicates with an input end of a hot runner of the heat exchanger B, an input end of the air output pipe communicates with an output end of the hot runner of the heat exchanger B, and an output end of the air output pipe communicates with the inner cavity of the storage tank (1).

17. An air liquefaction apparatus, comprising: a compression and cooling device, an expander, a heat exchanger B, an air input pipe, an air output pipe, and the liquid air storage device according to claim 4, wherein an output end of the compression and cooling device communicates with an input end of the expander through a pipeline, an output end of the expander communicates with an input end of a cold runner of the heat exchanger B through a pipeline, an output end of the cold runner of the heat exchanger B communicates with an input end of the compression and cooling device through a pipeline, an output end of the air input pipe communicates with an input end of a hot runner of the heat exchanger B, an input end of the air output pipe communicates with an output end of the hot runner of the heat exchanger B, and an output end of the air output pipe communicates with the inner cavity of the storage tank (1).

18. The air liquefaction apparatus according to claim 14, wherein the compression and cooling device comprises a compressor A, a cooler A, a compressor B, and a cooler B, wherein an output end of the compressor A communicates with an input end of the cooler A through a pipeline, an output end of the cooler A communicates with an input end of the compressor B through a pipeline, an output end of the compressor B communicates with an input end of the cooler B through a pipeline, an output end of the cooler B communicates with the input end of the expander, and the output end of the cold runner of the heat exchanger B communicates with an input end of the compressor A through a pipeline.

19. The air liquefaction apparatus according to claim 14, further comprising: a refrigerant B supplement pipe, a refrigerant B discharge pipe, and a pressure tester, wherein the pressure tester is disposed on the pipeline between the output end of the cold runner of the heat exchanger B and the input end of the compression and cooling device, both an output end of the refrigerant B supplement pipe and an input end of the refrigerant B discharge pipe communicate with the pipeline between the output end of the cold runner of the heat exchanger B and the input end of the compression and cooling device, a valve A is provided on the refrigerant B supplement pipe, and a valve B is provided on the refrigerant B discharge pipe.

20. The air liquefaction apparatus according to claim 14, further comprising a heating refrigerant gas pipe, wherein an output end of the heating refrigerant gas pipe communicates with the output end of the expander.
